(19) United States
(12) Patent Application Publication
(10) Pub. No.: US 2013/0170842 A1
(43) Pub. Date: Jul. 4, 2013

(54) Method and System for Equalization and Decoding Received Signals Based on High-Order Statistics in Optical Communication Networks

(71) Applicants: Toshiaki Koike-Akino, Cambridge, MA (US); Chunjie Duan, Brookline, MA (US); Kieran Parsons, Cambridge, MA (US); Keisuke Kojima, Weston, MA (US)

(72) Inventors: Toshiaki Koike-Akino, Cambridge, MA (US); Chunjie Duan, Brookline, MA (US); Kieran Parsons, Cambridge, MA (US); Keisuke Kojima, Weston, MA (US)

(21) Appl. No.: 13/343,133

(22) Filed: Jan. 4, 2012

(51) Int. Cl. H04B 10/06

(52) U.S. Cl. 398/208

(57) ABSTRACT

A method equalizes and decodes a received signal including a sequence of symbols. Subsequences of the signal are selected, wherein the subsequences are overlapping and time shifted. For each subsequence, statistics of the channel corresponding to a pattern in the subsequence are selected, wherein the statistics include high-order statistics. A transmitted signal corresponding to the received signal is then estimated based on the statistics.

### FIELD OF THE INVENTION

This invention relates generally to communication networks, and more particularly to equalizing and decoding coherently received optical signals.

### BACKGROUND OF THE INVENTION

A desire to increase the data rate and transmission distance of communication channels has driven engineers and designers to consider the use of coherent signal transmissions, e.g., in optical networks. Conventionally, optical communication networks have relied on the use of simple signalling methods to encode data bits onto an optical carrier.

The most common signalling method is intensity modulation, in which a laser is gated to allow high intensity light to enter a fiber optical cable when a ‘1’ bit is transmitted, and low intensity light when a ‘0’ bit is transmitted. This is called on-off keying. This signalling method has the advantage that it is easily demodulated by a simple detector including a photodetector (typically a photo-diode) and an appropitate threshold.

The main drawback of intensity signalling is that bandwidth efficiency is low, due to the fact that data are transmitted only in a single dimension, i.e., signal intensity. Coherent signalling methods allow for the transmission of multidimensional signals, by modulating both the intensity and the phase of the light emitted by the laser. This increases bandwidth efficiency.

Optical Communication Network

FIG. 1 shows a simplified conventional optical communication network 100 using coherent signaling. A transmitter 110 includes a laser light source 101, whose output is a constant beam of light, or pulses. The beam is input to a modulator 102, which is capable of modulating both the amplitude and the phase of the light using the input from a data source 103. Thus, the combination of laser and modulator is capable of generating any common two-dimensional digital modulation format, e.g., Quadrature Phase-Shift-Keying (QPSK), 8-PSK, or 16-Quadrature Amplitude Modulation (QAM). After modulation, the two-dimensional signal is passed through an optical channel, 104, and is detected and demodulated in a receiver 120.

The transmitter 110 typically includes a forward error correction (FEC) encoder, and an FEC decoder 107 in the receiver 120, to ensure reliability in the presence of noise, because advanced modulation schemes reduce Euclidean distances between symbols. The coherent receiver 120 includes another laser light source 101, optical hybrid, demodulator and photo detectors (termed a “coherent detector”) 106.

Several impairments affect the performance of such coherent optical transmission systems. The fiber channel exhibits Chromatic Dispersion (CD), Polarization Mode Dispersion (PMD), non-linear distortion such as Self-Phase Modulation (SPM), and so on. Nonlinear impairments have become a major limiting factor for high-rate data transmissions in long-haul optical fiber channels.

In the prior-art, Digital Back-Propagation (DBP) inverts the channel linear and nonlinear effects using a technique similar to the conventional split-step Fourier method (SSFM) for optical fiber modeling. However, the DBP suffers from high complexity in implementations and has reduced effectiveness in the presence of Amplified Spontaneous Emission (ASE) noise in optical amplifiers. Parameters used in the DBP generally need to be manually adjusted to obtain the best performance. Other nonlinear compensation techniques include Regular Perturbation and Volterra series expansion. Nevertheless, performance and implementation complexity remain a challenge.

FEC coding can reduce the bit error rate (BER) in channels with impairments. Soft-input Low-Density Parity-Check (LDPC) codes have been used for high-rate optical communications. A 2-bit soft-input LDPC code achieves over 9 dB net coding gain with 20% overhead.

Turbo Equalization

Turbo Equalization (TEQ) was originally developed to deal with inter-symbol interference (ISI) in wireless channels, and is very effective, and can approach channel capacity with low-complexity implementations. A “turbo loop” is formed between a Maximum A posteriori (MAP) equalizer and a Soft-Input Soft-Output (SISO) decoder that exchange belief messages, termed extrinsic information. TEQ, for non-coherent fiber-optic nonlinear transmissions, uses a Bahl-Cocke-Jelinek-Raviv (BCJR) MAP equalizer with probability functions obtained from training sequences. Significant performance improvements have been obtained in simulations, but the complexity is too high to be realistically implemented in high-rate applications, such fiber-optic communications.

A reduced-complexity symbol detector uses a training sequence to generate mean levels at the receiver for each of the possible patterns of consecutive symbols. After training, each symbol is decoded by determining a minimum Euclidean distance of an L-symbol received sequence to each of the possible transmitted patterns. An increase in nonlinear tolerance of 2 dB can be obtained. Such system uses only the first-order statistics (mean values), and therefore offers limited performance improvement.

### SUMMARY OF THE INVENTION

Embodiments of the invention provide a low-complexity receiver in a communications network. The receiver uses a “sliding window” equalizer. The sliding window equalizer estimates a likelihood of transmitted symbols based on a received symbol sequence using statistics of the optical channel. The equalizer can be symbol-spaced, or fractional-spaced. The statistics include but are not limited to the mean, the variance and covariance of the signals.

In one embodiment of the invention, the sliding window MAP equalizer is combined with a SISO FEC decoder to form a Turbo Equalization (TEQ) structure in the receiver. The MAP equalizer and the SISO decoder operate iteratively on the received symbol sequence for a number of iterations, or until a termination condition is met. The sliding window MAP equalizer enables much lower complexity implementations than the conventional BOR MAP equalizer.

In another embodiment of the invention, the sliding window equalizer is used in a Maximum-Likelihood Sequence Estimator (MLSE) using Viterbi decoding, or other sequence estimation procedures, such as Fano sequential decoding.

The sliding window equalizer can be combined with other pre-, and post-equalization schemes, such as a channel shortening linear equalizer or a DBP to further enhance the performance of the receiver.

Embodiments of invention also provide a method for establishing high-order statistics of the optical channel, and updating the high-order channel statistics periodically or continuously over successive symbols or over iterations of turbo loops. In addition, the statistics include first-order, second and higher orders, e.g., mean, covariance, skewness and kurtosis.

### BRIEF DESCRIPTION OF THE DRAWINGS

FIG. 1 is a schematic of a conventional coherent optical communication network;

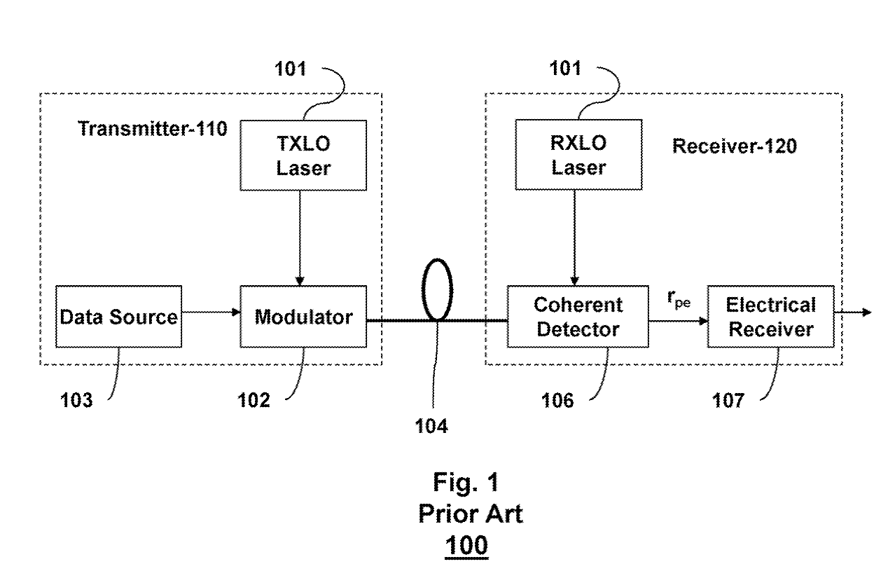

FIG. 2A is a block diagram of a coherent fiber-optic network with a fractionally-spaced statistical sequence equalizer according to embodiments of the invention;

FIG. 2B is a schematic of a sliding window maximum likelihood equalizer according to embodiments of the invention;

FIG. 3 is a schematic of a procedure of a channel statistics analyzer according to embodiments of the invention;

FIG. 4 is a schematic of a TEQ receiver according to embodiments of the invention;

FIG. 5 is a schematic of details of a sliding window MAP equalizer according to embodiments of the invention;

FIG. 6 is a schematic of a pipelined implementation of the TEQ receiver according to embodiments of the invention;

FIG. 7 is a schematic of continuously determining the a posteriori probability in turbo loops according to embodiments of the invention; and

FIG. 8 is a schematic of a sliding window MLSE equalizer according to embodiments of the invention.

### DETAILED DESCRIPTION OF THE PREFERRED EMBODIMENT

Coherent Fiber-Optic Network

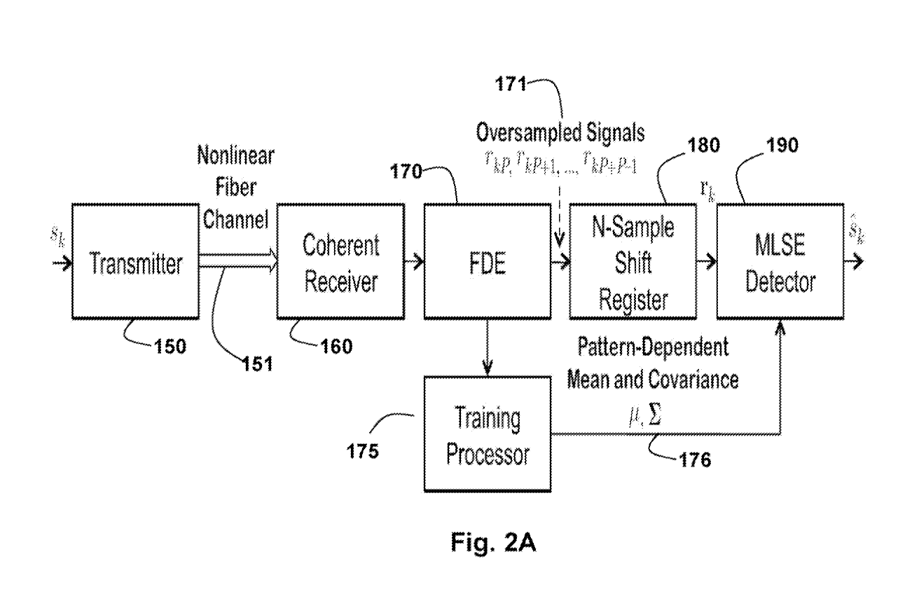

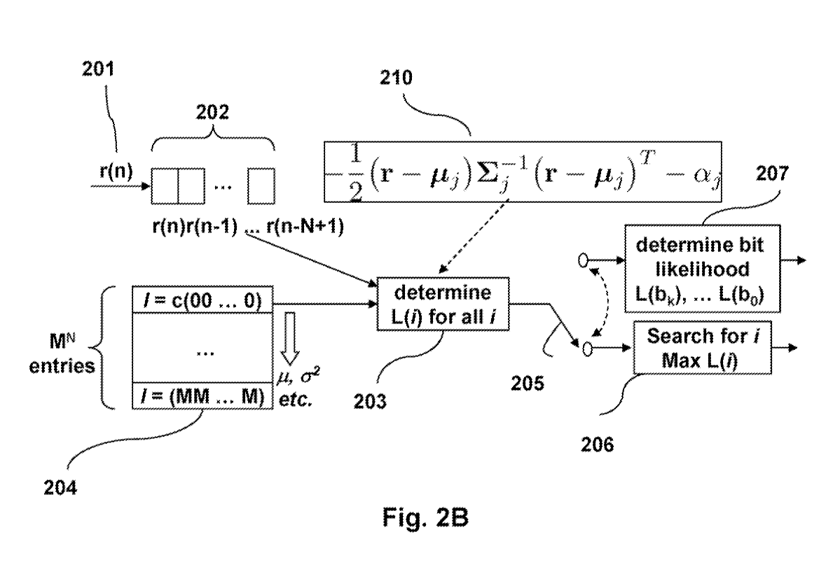

FIG. 2A shows a coherent fiber-optic network with a fractionally-spaced statistical sequence equalizer according to embodiments of our invention.

A transmitter 150 transmits symbols sₖ via a nonlinear fiber optical channel 151 to a coherent receiver 160. After digitizing to, e.g., two samples per symbol, residual dispersion is removed using linear frequency-domain equalizer (FDE) 170. The oversampling signal is fed into a shift register 180 to obtain subsequences, and then a statistical Maximum-Likelihood Sequence Estimator (MLSE) equalizer 190 to determine an estimate of the transmitted signal. The MLSE detector 190 uses channel statistics 176, learned by a training processor 175. The channel statistics include high-order statistics, such as mean, covariance, skewness and kurtosis.

The invention is based on the realization that nonlinear distortion highly depends on patterns in the transmitted signal. Therefore, the statistical sequence equalizer first acquires such pattern dependent distortion characteristics by averaging the received sequence with training data, or an on-line learning process. The trained mean signals are then used to decode by searching for a minimum Euclidean distance from the received sequence. We use second and higher-order statistics (covariance) in addition to the first-order statistics (mean) to reduce residual nonlinear noise. In addition, we use fractionally-spaced processing with expanded window size to improve the performance through the use of the correlation over adjacent received samples.

Furthermore, we provide fractionally-spaced processing with a larger window to improve the performance by using correlation over adjacent received samples.

Sliding Window Estimator (SWE)

FIG. 2B shows an embodiment of a sliding window estimator (SWE) by way of an example.

A sequence of discrete symbols r(n) 201 is received at an output of an optical channel or a pre-processing unit. The symbols are either symbol-spaced samples, or fractionally-spaced samples. The symbols arc fed to an N-length shift register 202, where N is a size of a sliding window, in teens of symbols. The shift register produces subsequences that are overlapping and time shifted

The SWE generates likelihood information of a transmitted symbol s(m) based on the received symbol sequence. The symbol position m can be any arbitrary posit⁻ion within the sequence. The position m is typically selected to be the middle symbol of the sequence, i.e., m=n−N/2+1.

At a likelihood calculator 203, the SWE estimates a likelihood Pr(R|S=Pj) of transmitted symbols S=s(n)s(n−1) . . . , s(n−N−1), given the received symbol sequence R=r(n), . . . , r(n−N+1), for all possible N-symbol patterns Pⱼ. Note that there are M^{N} patterns, where M is the number of modulation constellations, e.g., for QPSK, M=4.

Although the example is described for a single polarization system, it is understood that the invention can be extended to a dual-polarization multiplexed system. The dual-polarization application can include combined and individual use of the SWE, where the number of patterns for the combined case is M^{(2N)}, and that of the individual case is 2M^{N}. Another embodiment uses individual SWE for x/y-polarizations. Decisions are fed into the combined SWE as a successive polarization nonlinearity canceller.

The number of patterns can be reduced by a kernel filter and clustering for higher-level modulations. The window size of the transmitted symbol sequence can differ from that of the received symbol sequence, specifically, S=s(n)s(n−1), . . . , s(n−Nₛ−1) and R=r(n), . . . , r(n−Nᵣ+1) for window sizes Nₛ and Nᵣ. Typically, the window size of the transmitted symbol sequence is no longer than an over-sampling factor multiplied by the window size of the transmitted symbol sequence. The window size can be adaptively optimized by tracking an effective memory of the channel.

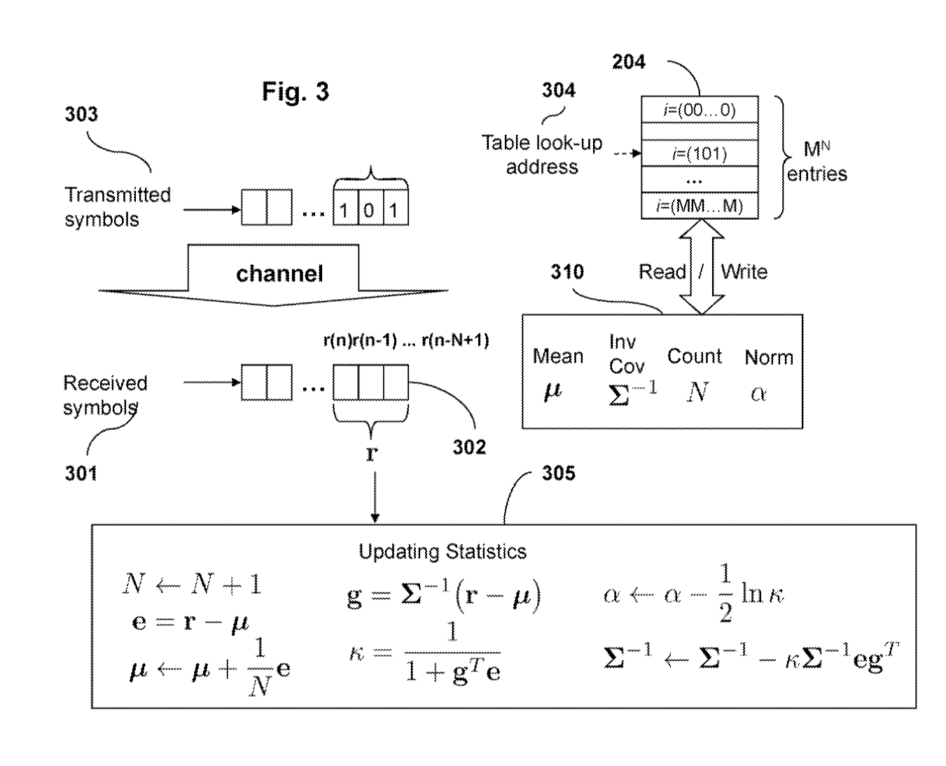

The SWE uses channel statistics of the channel to estimate the likelihood. The channel statistics, including the pattern-dependent covariance, are obtained by a channel statistics analyzer at the receiver, see FIG. 3, and are stored in the pattern-dependent channel statistics look-up table 204. Complexity can be reduced by symmetry of the pattern and modulation.

Given the channel statistics for the j^{th} pattern such as the first order mean μⱼ and the second order covariance Σⱼ and its inverse Σ⁻¹ⱼ, a likelihood Pr(R|S=Pⱼ) 210 is estimated as

$$Pr ( R \vert S = {P}_{j} ) = - \frac{1}{2} ( r - {μ}_{j} ) {\sum }_{j}^{- 1} {( r - {μ}_{j} )}^{T} - {σ}_{j} , \qquad ( 1 )$$

where Tis a transpose operator, and σⱼ are covariances.

The SWE can be used as a standalone hard-output Maximum-Likelihood (ML) symbol detector. In such a case, the switch 205 is connected to the block 206, which searches for the most likely estimate ŝ(m) with the maximum likelihood value as

$$\hat{s} ( m ) = arg {max}_{j} Pr ( R \vert S = {P}_{j} ) \qquad ( 2 )$$

The SWE can also generate the soft-output likelihood of the symbol L(s(m)) when switching to block 207. This soft information can be used as the input to the following blocks that accepts soft input e.g., for SISO FEC decoder. Typically, the soft-output detector provides better performance than the hard-output detector.

Channel Statistics Analyzer

FIG. 3 shows the example process of obtaining the channel statistics at the channel statistics analyzer. The channel statistics analyzer (CSA) can be implemented and controlled in the receiver. During the time when a known pattern, e.g., training symbols or error-free decoded symbols, is being received, the receiver activates the CSA, which accepts the input symbol sequence r(n)r(n−1) . . . , 301 in a shift register 302, and determines the mean (μ) and the covariance (σₓₓ, σ_{yy}, σ_{xy}, σ_{yx}) of the received signals for each N-symbol subsequence of a total of M^{N} pattern entries. The statistics 310 are stored in the channel statistics look-up table 204 using a transmitted sequence 303 as a corresponding table address 304. Note that even higher-order statistics such as skewness and kurtosis can be determined and used for more accurate modeling of the nonlinear fiber.

For a given pattern s, the mean is

$$μ ( s ) = \frac{1}{𝒩 ( s )} {\sum }_{j : {s}_{j} = s} {r}_{j} . \qquad ( 3 )$$

The covariance matrix is

$$\sum = [ \begin{matrix}{α}_{xx} & {α}_{xy} \\ {α}_{xy} & {α}_{yy}\end{matrix} ]$$

is

$$\sum ( s ) = \frac{1}{𝒩 ( s ) - 1} {\sum }_{j : {s}_{j} = s} {[ \begin{matrix}ℜ [ {r}_{j} - μ ( s ) ] \\ [ {r}_{j} - μ ( s ) ]\end{matrix} ] [ \begin{matrix}ℜ [ {r}_{j} - μ ( s ) ] \\ [ {r}_{j} - μ ( s ) ]\end{matrix} ]}^{T} , \qquad ( 4 )$$

where [symbol] is the number of received sequences corresponding to transmitted pattern s, with represent element-wise real and imaginary parts, respectively [symbol] (·) and ℑ(·) represent element-wise real and imaginary parts, respectively. The mean and the covariance matrix, as well as its inverse version, can be updated 305 sequentially with low-complexity processing. In FIG. 3, e,g and κ are temporary variables for sequential updating.

In one embodiment, the channel statistics analyzer determines the statistics using a training sequence. If the channel is stationary during operation, then the statistics remain unchanged.

In another embodiment, a receiver periodically receives training sequences and subsequently activates the channel statistics analyzer to update 305 the channel statistics. Thus, the channel statistics are adjusted for time-variation of channel characteristics.

Turbo Equalization Receiver

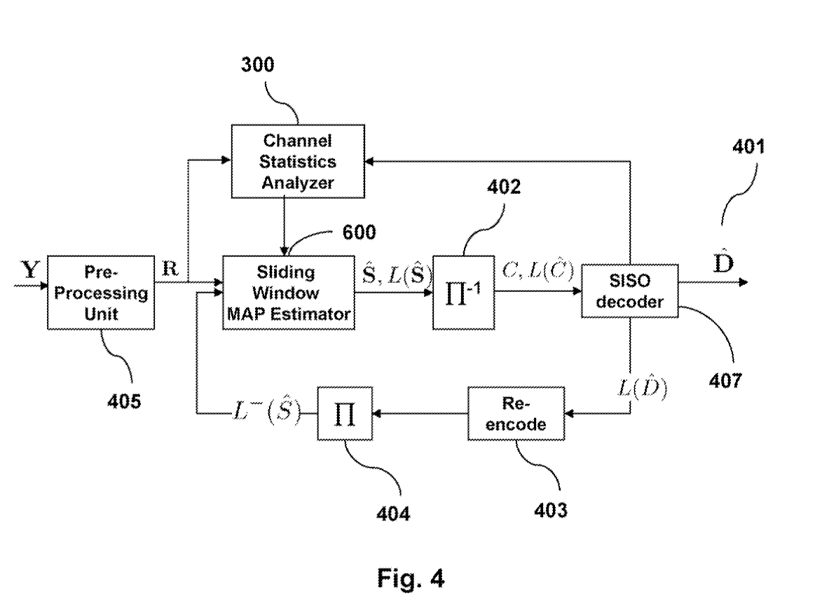

FIG. 4 shows another embodiment. The receiver continuously updates the channel statistics using the received data symbols Y 301, instead of using the training symbols. The received signals, after preprocessing 405, are fed to the channel statistics analyzer 300 to update the channel statistics. The channel statistics are used by a MAP estimator 600, to estimate the transmitted signal Ŝ, and its likelihood L(Ŝ).The statistics are highly adaptive and can reflect sudden changes of characteristics of the channel.

As shown in FIG. 4, the turbo equalization receiver can use the sliding window MAP estimator 600 and a SISO FEC decoder 407.

In the turbo equalization receiver, the SW MAP estimator 600 is connected to an SISO decoder. The SWE MAP estimator outputs the log-likelihood ratio of symbols L(ŝ(m)). A de-interleaver (Π′) 402 decorrelates the symbols in the sequence and produces likelihood L(Ĉ(m)) corresponding to the de-interleaved sequence Ĉ=Π⁻¹(Ŝ). The SISO decoder decodes L(Ĉ(m)) and either outputs the hard-decoded symbol sequence \hat{D} 401, or soft-output data sequence likelihood L(\hat{D}), often called extrinsic information. Then, L(\hat{D}) is re-encoded 403 and re-interleaved (Π) 404 to generate the a priori probability of the transmitted sequence, denoted as L⁻¹(Ŝ), which is fed back to the MAP estimator 600.

Iterative TEQ Receiver

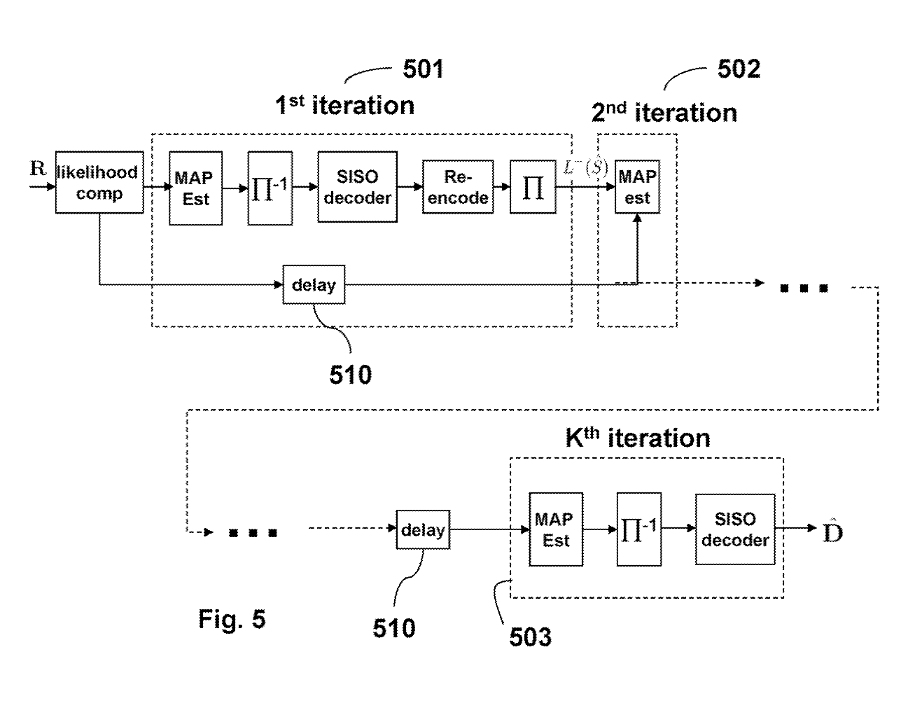

As shown in FIG. 5, the TEQ receiver can operate in an iterative fashion. FIG. 5 shows the 1^{st}, 2^{nd}, K^{th} iterations 501-503 with a delay 510 between each iteration. The operational blocks and variables in the Fig. are as described for FIG. 4.

The output of the SWE MAP estimator is fed into the SISO decoder and the output of the SISO decoder is fed back into the SWE MAP estimator. This iterative process continues until the number of iteration K reaches a pre-defined threshold, or a termination condition is met. The iterative TEQ receiver can be implemented in a pipeline manner as shown in FIG. 5. The outputs of one iteration are fed into the next iteration. Given that the received sequence likelihood is determined, the delays 510 are needed between iterations for the sequence likelihood. The pipelined TEQ implementation requires more hardware resources but can operate at a much higher symbol rate, which is more suitable for ultra-high-speed optical communications, at or beyond 100 Gbps per channel.

In one embodiment, the TEQ receiver can include any pre-processing unit, such as prior-art DBP, or a frequency-domain chromatic dispersion equalizer. This can yield a substantial performance gain, while the window size can be relatively small for low-complexity implementation. Similarly, the transmitter can use any pre-compensation techniques including pre-distortion, pre-coding, pre-DBP, pre-equalizer for performance enhancement. In one embodiment, the TEQ receiver can be simplified to a MLSE equalizer for hard-decision decoder, instead of using the SISO decoder.

Sliding Window MAP Estimator

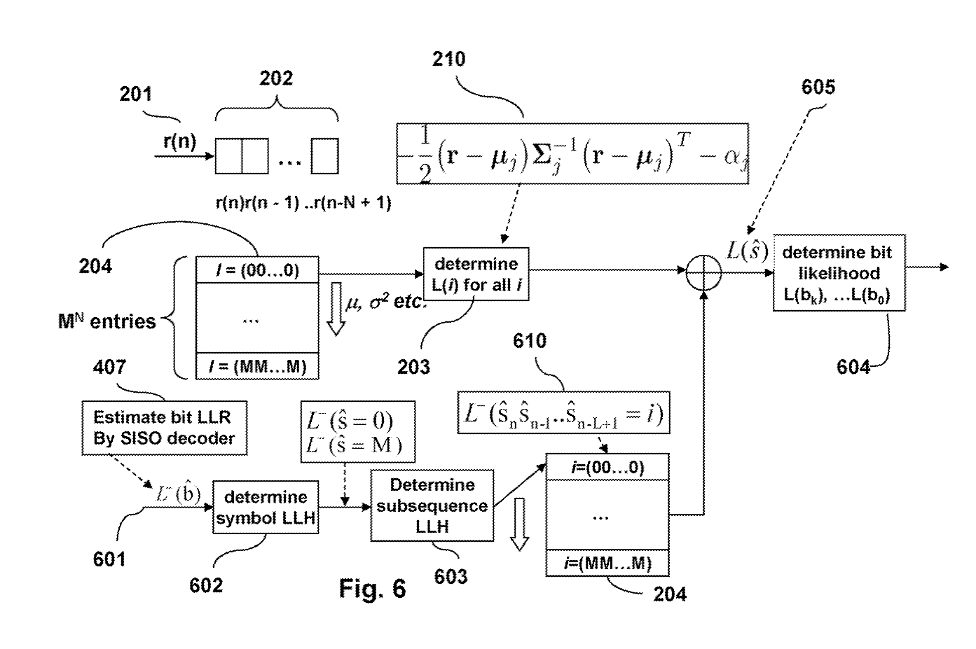

The sliding window MAP estimator 600 is shown in FIG. 6. Similar to the sliding window ML estimator, the received signal R 201 is used to determine the sequence likelihood Pr(S=Pⱼ|R) 203 as in Equation (1). The major difference is that the sliding window MAP estimator 600 accepts the soft-output message from SISO decoder 407.

The a priori probability of the sequence is determined based on the a priori likelihood of the transmitted sequence, which is re-encoded from the soft output 601 of the SISO decoder 407. The a priori probability of each encoded symbol. L⁻(ŝ) is determined 602 first. The a priori probability of the encoded symbol sequence L⁻(ŝₙ . . . ŝ_{n-L+1}) 610 is then computed 603, and the a priori probability of all possible transmitted sequence 610 is computed and stored in a table 204.

The a priori probability 204 is then combined with the probability of the received sequence 203 to produced a posteriori probability of the received sequence, which is then used to compute the a posteriori probability of the received symbol in the sequence L(ŝ) 605. The a posteriori probability of the bits is then determined 604.

In particular, for all possible sequences, the a priori likelihood 610

L⁻¹(s(n)s(n−1) . . . s(n−L+1)=i) (5)

is derived directly from the likelihood of the bit, or symbol sequence re-encoded from the data sequence likelihood L(\hat{D}).

The a posteriori likelihood is therefore determined 604 as

L(s|\hat{r})=L(r|s)+L⁻(i)+c, (6)

where c is a constant, and does not need to be determined.

For the MAP symbol hard-decision detector, the estimated transmitted symbol is

$$\hat{s} ( m ) = arg { max}_{j} Pr ( S = {P}_{j} \vert R ) . \qquad ( 7 )$$

Similarly, the soft likelihood L(S=i|R) of the symbol S(m), can be calculated based on the a posteriori probability of the sequence.

Sliding Window MAP Estimator

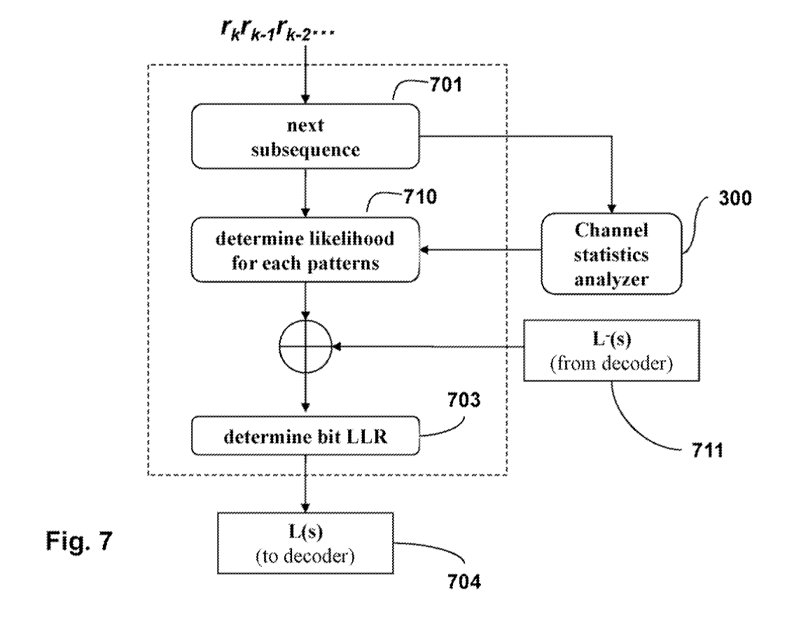

FIG. 7 shows the overall process in the sliding window MAP estimator. To remove any intrinsic information, only a difference of the likelihood of the output sequence and input sequence at the decoder is used for determining the a priori likelihood.

For each subsequence 701, determine 710 the likelihood for each pattern based on the channel statistics. Then, determine 702 the log Likelihood ratios (LLR) of the bits based on the a priori likelihood L⁻ 711 (produced by the decoder) to produce L(s) 704 for the decoder.

Sliding Window ML Estimator

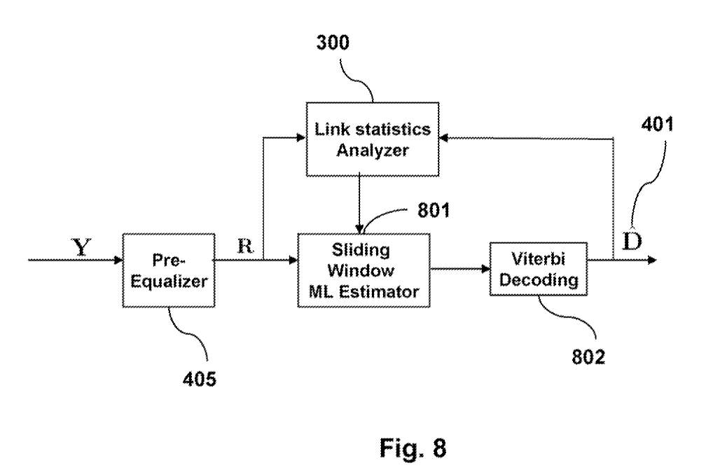

As shown in FIG. 8, the sliding window MAP estimator is replaced with the sliding window ML estimator 801 for the case when the decoder cannot accept soft-input information, or cannot generate soft-output information. The soft-output likelihood information given by the sliding window ML estimator is fed into the sequence decoder 802, such as the Viterbi decoding 802 to produce decoded data D 401. For the Viterbi decoding, any known reduced-complexity procedure, such as a MIT-algorithm and delayed decision feedback scheme can be adopted for low-complexity applications. Note that the sliding window MLSE equalizer has lower latency than the sliding window TEQ equalizer.

Although the invention has been described for an example optical network with single polarization, the embodiments can also be used for optical networks with polarization multiplexed signal, of for other wired and wireless communication systems.

### Effect of the Invention

Embodiments of the invention provide a fractionally-spaced equalizer second and higher-order statistics obtained by training to deal with nonlinear impairment in coherent optical communications. The equalizer improves the Q-factor by more than 2 dB for long-haul transmissions of 5,230 km.

The statistical sequence equalizer maintains 2 dBQ improvement even at 10,460 km for low dispersion case, whereas the improvement is considerably reduced for high dispersion case. It indicates that an equalizer with a small number of taps can work with other channel shortening methods for long-haul transmissions.

Using the likelihood described above, the statistical equalizer uses the maximum-likelihood sequence estimation (MLSE) to detect the transmitted symbols with a Viterbi algorithm. Because the computational complexity of MLSE grows exponentially with the channel memory, more specifically O[N4M], we can use a channel shortening equalizer including frequency-domain chromatic dispersion compensation or reduced-complexity DBP. We obtain higher than 2 dBQ with a short memory MLSE using just M=3 taps, that can outperform the DBP.

Another embodiment uses a low-complexity turbo equalizer with a sliding window (SW) MAP estimator, and a low overhead, small block-size SISO LDPC decoder. The ML estimator alone provides a 2.5˜4 dB gain in Q-factor over existing sliding window detector, and the turbo equalizer provides an additional ˜1 dB improvement in a nonlinear fiber channel over 5,000 km.

The equalizer outperforms conventional Digital Back-Propagation (DBP), which uses hundreds of SSF.M iterations, in low dispersion channels. Even for high-dispersion channels, the fractionally-spaced 3-tap equalizer achieved comparable performance in peak Q factor to the DBP.

The SW-ML detector out-performs the conventional SW-Minimum Distance (MD) detector by as much as 5 dB for the low dispersion channel, and 2-3.5 dB for a high dispersion channel. For an equalized linear channel, where symbols are considered independent and have equal variance, the SW-ML and SW-MD detectors have identical performance. This confirms that using the 2^{nd} order statistics provides performance gain in non-linear channels. A performance improvement of 4 dB or higher can be achieved in 40 G bps non-return-to-zero (NRZ) quadrature phase-shift keying (QPSK) transmissions.

The turbo equalizer structure uses the SW-MAP estimator and the LDPC decoder with a short block size. The SW-MAP estimator utilizes multi-symbol sequence and second-order statistics to produce reliable likelihood information for a following SISO LDPC decoder. The complexity of the turbo equalizer is sufficiently low, and can be implemented in hardware. There is a significant BER performance and Q-factor improvement over prior art techniques.

The sliding window equalizer and receivers based on the SWEQ are effective in mitigating non-linear effect of the fiber channel.

For SWE-based TEQ receiver, we analyze the QPSK performance with a window size of L=3 symbols in a low local dispersion channel (1551.32 nm wavelength) and a high local dispersion channel (1561.01 nm wavelength).

Over the entire range of launch power simulated, the SW-ML detector out-performs the conventional Minimum Distance detector by as much as 5 dB for the 1551 nm channel and 2 to 3.5dB for the 1561 nm channel.

For an equalized linear channel, where symbols are considered independent and have equal variance, the SW-ML and SW-MD detectors have identical performance. This further confirms our analysis that using the 2^{nd} order statistics provides performance gain in non-linear channels. For example, in high dispersion channel with 3.25 dBm launch power, the Q at the SW-MAP estimator is 6.92 dB, the decoder output is 10.02 dB after the initial iteration and improves to 10.31 dB and 10.93 dB after the 1^{st} and 2^{nd} iteration. The overall gain is greater than 7 dB at 0.5 dBm launch power for the low dispersion channel and 6.5 dB at 3.25 dBm launch power for the high dispersion channel.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for equalizing and decoding a received signal via a channel in a receiver of a communication network, wherein the signal includes a sequence of symbols, comprising the steps of:
selecting subsequences of the signal, wherein the subsequences are overlapping and time shifted;
selecting, for each subsequence, statistics of the channel corresponding to a pattern in the subsequence, and wherein the statistics include high-order statistics; and
estimating a transmitted signal corresponding to the received signal, based on the statistics, wherein the steps are performed in the receiver.
